(19) United States
(12) Patent Application Publication
(10) Pub. No.: US 2012/0024843 A1
(43) Pub. Date: Feb. 2, 2012

(54) THERMAL TREATMENT OF CARBONACEOUS MATERIALS

(75) Inventors: Vitali V. Lissianski, Schenectady, NY (US); R. George Rizeq, Mission Viejo, CA (US); Raul Fernando Subia, Garden Grove, CA (US); Surinder Prabhjot Singh, Tustin, CA (US)

(73) Assignee: GENERAL ELECTRIC COMPANY, SCHENECTADY, NY (US)

(21) Appl. No.: 12/847,672

(22) Filed: Jul. 30, 2010

(51) Int. Cl. H05B 6/64

(52) U.S. Cl. 219/678

(57) ABSTRACT

A method of treating a carbonaceous material is disclosed. The method includes heating the carbonaceous material in a reactor with microwave energy, at a pressure less than about 5 atmospheres, to generate a mixture comprising char, oil and gas.

### STATEMENT REGARDING FEDERALLY SPONSORED RESEARCH AND DEVELOPMENT

This invention was made with Government support under contract number HR0011-09-C-0091, awarded by the Defense Advanced Research Projects Agency (DARPA), U.S. Department of Defense. The Government has certain rights in the invention.

### BACKGROUND

The invention relates to a method of treating a carbonaceous material and in particular, the invention relates to a method of treating the carbonaceous material with microwave energy.

A pyrolysis process is the low temperature heating of organic material in the absence of an external supply of oxygen. The heating of the material causes devolatilization and produces a mixture of light gases, tar oils and char. Pyrolysis is usually carried out at low temperatures as compared to gasification, to maximize the yield of tar oils. The characteristics of the pyrolysis composition (called pyro-oil) depends on a number of factors such as temperature, residence time, pressure, heating rate, and the like. The liquids generated from pyrolysis are generally low in quality and need considerable upgrading to remove aromatics and increase hydrogen composition. However, pyrolysis oils can be transformed into valuable products. A conventional method of supplying heat for pyrolysis is to combust externally part of the feedstock, and then transfer the heat to the pyrolysis vessel. As this method relies on conventional heat transfer, it requires slow feedstock heating rates, and the yield of these oils is low (usually less than 20% wt). The low yields can negatively affect process economics. Flash pyrolysis of materials like coal and biomass results in much faster feedstock heating rates, and usually is based on the injection of micronized feedstock particles into the hot gases, resulting in higher yields of the pyrolysis oil. However, the disadvantage of this method is that the particle size reduction is an energy intensive process, and is often expensive.

Microwave heating is a more effective way to transfer heat to the material. Typically, the efficiency of electricity conversion to microwave energy is about 80%. Microwaves transfer heat directly to the material, and the waves are absorbed by the material volume, and not just the surface, as in conventional heating. Microwave processing has been used in a broad range of applications, due to the potential benefits of the approach, which include uniform heating, fast reaction times, and good energy efficiency. Microwave processes have advantages, in that they can potentially use renewable energy in the form of electricity, as opposed to conventional fossil fuel based heating approaches. In addition, a microwave process is in many cases a cleaner, faster and more uniform process than the conventional approaches to heating. Microwave processes can be used in a wide range of temperatures ranging from about 20° C. to over 6000° C. Microwave processing has been applied to a variety of applications, such as to break oil and water emulsions, refinement, and the upgrading of industrial chemicals. Microwaves have also been used in industrial heating processes for sterilization, pasteurization, and other treatments of heat-sensitive materials—typically in ranges from 50° C. to 2000° C.

There is a continuing need for a method for the treatment of carbonaceous material that optimizes heating conditions, while producing a high yield of the pyrolysis oil. At a minimum, in order to be commercially viable, such technology would desirably be utilized at a relatively low cost, and would also utilize a carbonaceous material to obtain oil in high yields.

### BRIEF DESCRIPTION

One aspect of the present invention provides a method of treating a carbonaceous material. The method includes heating the carbonaceous material in a reactor with microwave energy at a pressure less than about 5 atmospheres, to generate a mixture comprising char, oil and gas.

Another aspect of the present invention provides a method of treating carbonaceous materials. The method includes heating the carbonaceous material in a reactor with microwave energy at a pressure less than about 5 atmospheres, and a temperature in a range of about 400° C. to about 800° C., to generate a mixture comprising char, oil and gas.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic representation of the method for treating a carbonaceous material according to an embodiment of the invention.

FIG. 2 is a plot of oil yield as a function of temperature, according to an embodiment of the invention.

FIG. 3 is a plot of oil yield as a function of temperature, according to another embodiment of the invention.

### DETAILED DESCRIPTION

While only certain features of the invention have been illustrated and described herein, many modifications and changes will occur to those skilled in the art. It is, therefore, to be understood that the appended claims are intended to cover all such modifications and changes as fall within the true spirit of the invention. In the specification and claims, reference will be made to a number of terms, which have the following meanings.

The singular forms “a”, “an” and “the” include plural referents unless the context clearly dictates otherwise. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Similarly, “free” may be used in combination with a term, and may include an insubstantial number, or trace amounts, while still being considered free of the modified term.

As used herein, the terms “may” and “may be” indicate a possibility of an occurrence within a set of circumstances; a possession of a specified property, characteristic or function; and/or may qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances, an event or capacity can be expected, while in other circumstances, the event or capacity cannot occur—this distinction is captured by the terms “may” and “may be”.

“Optional” or “optionally” means that the subsequently described event or circumstance may or may not occur, and that the description includes instances where the event occurs and instances where it does not.

The terms “oil”, “oils” or “bio-oil” mentioned herewith refer to oils such as pyrolysis oil, which is produced by thermochemical processing, such as the pyrolysis of waste feedstocks or carbonaceous material.

As previously noted, in one embodiment, the present invention provides a method of treating a carbonaceous material. The method includes heating the carbonaceous material in a reactor with microwave energy at a pressure less than about 5 atmospheres, to generate a mixture comprising char, oil and gas.

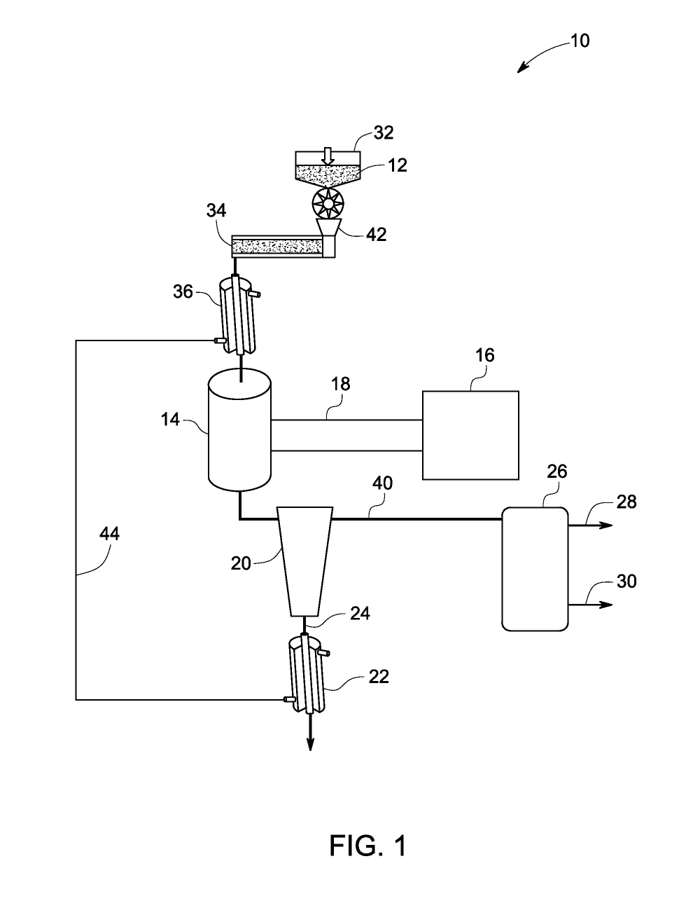

Referring to the drawings, identical reference numerals denote the same elements throughout the various views. Referring now to FIG. 1, a Block Flow Diagram (BFD) of a system 10 for the treatment of carbonaceous material is shown according to an embodiment of the invention. In one embodiment, the carbonaceous material 12 comprises coal. In one embodiment, the carbonaceous material 12 comprises at least about 70% coal, by weight. In another embodiment, the carbonaceous material 12 comprises at least about 75% coal. In yet another embodiment, the carbonaceous material 12 comprises at least about 90 percent coal. In one embodiment, the carbonaceous material 12 includes a bituminous coal, a powder river basin coal, a lignite coal or mixtures thereof. In one embodiment, the carbonaceous material 12 may comprise a mixture of coal and biomass. The term “biomass” covers a broad range of materials that offer themselves as fuels or raw materials, and are characterized by the fact that they are derived from recently living organisms (plants and animals). This definition clearly excludes traditional fossil fuels, since although they are also derived from plant (coal) or animal (oil and gas) life, it has taken millions of years to convert them to their current form. Thus the term biomass includes feedstocks derived from tree-based materials such as wood, woodchips, sawdust, bark, seeds, straw, grass, and the like; agricultural and forestry wastes; forest residues, agricultural residues; and energy crops. Agricultural residues and energy crops may further include short rotation herbaceous species, husks such as rice husk, coffee husk etc., maize, corn stover, oilseeds, residues of oilseed extraction, cellulosic fibers like coconut, jute, and the like. The oilseeds may be typical oil bearing seeds like soybean, camolina, canola, rapeseed, corn, cottonseed, sunflower, safflower, olive, peanut, and the like. Agricultural residue also includes materials obtained from agro-processing industries such as deoiled residue. Specific examples include a deoiled soybean cake, deoiled cottonseed, deoiled peanut cake, and the like, and gums from the oil processing industry, such as gum separated from the vegetable oil preparation process. These examples include lecithin in the case of soybean, bagasse, from the sugar processing industry, cotton gin trash, and the like. Biomass also includes other wastes from such industries, such as coconut shell, almond shell, walnut shell, sunflower shell, and the like. In addition to these wastes from agro industries, biomass may also include wastes from animals and humans. In some embodiments, the biomass includes municipal waste or yard waste, sewage sludge and the like. In some other embodiments, the term biomass includes animal farming byproducts such as piggery waste or chicken litter. The term biomass may also include algae, microalgae, and the like. In another embodiment, the term “carbonaceous material” 12 is meant to exclude material such as the municipal solid waste (MSW), for example, plastics, tires, wet organic waste, and the like.

The system 10 may comprise a feed hopper 32 that contains the carbonaceous material 12 to be treated, and a screw feeder 34 that pushes the carbonaceous material 12 to the reactor 14. In one embodiment, the carbonaceous material 12 may be ground to smaller particles in a grinder or shredder 42, prior to being fed into the screw feeder 34. In one embodiment, the screw feeder 34 pushes the carbonaceous material 12 through a pre-heater 36 that may heat the carbonaceous material 12, prior to entering the reactor 14.

In the reactor 14, the carbonaceous material 12 is heated with microwave energy. The microwave energy is generated in a magnetron 16. In one embodiment, the microwave energy thus generated in the magnetron 16 is transferred to the carbonaceous material 12 in the reactor 14, through a wave guide 18. In another embodiment, the microwave energy generated in the magnetron 16 is conveyed to the carbonaceous material 12 in the reactor 14 through a microwave tube (not shown). In one embodiment, the electricity needed to produce the microwave energy, may be provided by a renewable energy source, such as wind, solar, thermal, hydro, or other sources of renewable energy, to provide a self-contained energy system. In one embodiment, the microwave energy may be generated at a power in the range from about 100 kilo Watt per pound (kW/lb) to about 1,000 kilo Watt per pound (kW of power per lb of material). In another embodiment, the microwave energy may be generated at a power in the range from about 200 kilo Watt per pound (kW/lb) to about 500 kilo Watt per pound. In some embodiments, the frequency of the microwave energy generated is 800 MHz or 2.45 GHz. In another embodiment of the present invention, the treatment of the carbonaceous material 12 is carried out in the absence of a resonator.

The heating of the carbonaceous material 12 in the reactor is usually carried out at a pressure of less than about 5 atmospheres. In one embodiment, the heating of the carbonaceous material 12 in the reactor 14 is carried out at a pressure in a range from about 1 atmosphere to about 5 atmospheres. In one embodiment, the heating is carried out at a temperature in a range from about 400° C. to about 800° C.

Heating of the carbonaceous material 12 in the reactor 14, with microwave energy, generates a mixture that includes char, oil and gas. In some preferred embodiments depicted in FIG. 1, the treatment of the carbonaceous material 12 includes the step of separating the product mixture that includes char, oil and gas. In one embodiment, the separation of the mixture may be carried out in a cyclone 20 that is disposed downstream of the reactor 14. The char separated from the mixture in the cyclone 20 is drawn out through the char outlet 24. In one embodiment, the char outlet 24 may be situated at the bottom of the cyclone 20. The separated char may then be conveyed to a heat recovery unit 22. The heat recovered from the heat recovery unit 22 may then be recycled to the pre-heater 36, via the recycled heat path 44. In yet another embodiment, the separated char may be partially combusted and returned to the reactor 14 to supply the heat for the treatment of the carbonaceous material 12. In one embodiment, the char drawn from the heat recovery unit 22 may be further subjected to treatment such as, for example, char gasification. In another embodiment, the excess char that is obtained may be desulfurized, and used as a clean solid fuel, e.g., burned for energy. The char can also be used as a fertilizer—especially when the feedstock is made up of significant amounts of biomass.

The mixture of gas and oil 40 that is separated in the cyclone 20 may be fed into a separator unit 26. The separator unit 26 includes oil and gas separators, for example, heat exchangers that cool the stream to condense the oils out from the gas stream. The separator unit can include at least one fractionation column Gases that are produced during treatment of carbonaceous material 12 (and which can be separated from the recycle stream as mentioned above) may include hydrogen, carbon monoxide, carbon dioxide, water vapor, volatilized hydrocarbons, nitrogen, ammonia, methane hydrocarbons having about C1 to C30 carbon atoms, sulfur-containing compounds and combinations thereof. As used herein, the term “volatilized hydrocarbons” may refer to a portion of the gas which is produced by treatment of the hydrocarbon-portion of carbonaceous material 12. In one embodiment, the volatilized hydrocarbons and water vapor can be separated, and recovered by conventional separation and recovery means. A part of the volatilized hydrocarbons may be condensed. After the condensed hydrocarbons and any undesirable gaseous products have been removed from the product gases, the scrubbed hydrocarbon gases may be utilized as a carrier gas. In one embodiment, the carbon monoxide (CO) gas which is produced can be used outside of the process to produce useful oxygenates such as methanol (CH₃OH) and formaldehyde (CH₂O). The oil fraction may be collected in a condenser, and the gas may be collected in any suitable container. The unwanted materials may be purged out of the system through an exhaust.

In one embodiment, the oil constituent 30, separated from the separator unit 26, comprises a pyrolysis oil. In another embodiment, the oil separated from the separator unit 26 comprises at least about 40% of the initial feedstock material, i.e., a yield of 40%. Generally, the yield of the oil obtained from the treatment of carbonaceous material 12 using conventional methods is in the range from about 5% to about 15%. In one embodiment of the present invention, the yield of the oil obtained as a result of the treatment of carbonaceous material 12 is at least about 15%. In another embodiment, the yield of the oil obtained as a result of the treatment of carbonaceous material 12 is in a range from about 15% to about 80%. In another embodiment, the yield of the oil upon treatment of the carbonaceous material 12 can be enhanced by heating the carbonaceous material 12 at a very high heating rate, using microwaves, followed by a relatively rapid cooling of the product. This sequence slows secondary reactions that result in undesirable polymerization reactions, thereby increasing the oil yield. Microwave energy is ideally suited to provide high heating rates.

Microwave energy is transferred through the material electro-magnetically, not as a convective force or a radiative force. Therefore, the rate of heating is not limited by the surface transfer, and the uniformity of heat distribution is greatly improved. Heating times can be reduced to less than 1% of that required using conventional techniques. In one embodiment, the heating of the carbonaceous material 12 with microwaves may be precisely controlled with respect to the amount of heat applied, such that a precise temperature may be maintained at all times. In other words, substantially all portions of the carbonaceous material 12 are exposed to the same temperature. For example, the center of each “lump” of carbonaceous material 12 is at the same temperature as the surface of that lump, and the bottom of the reactor 14 is at the same temperature as the top. Thus, the chemical products formed from the carbonaceous material 12, under the effect of the heat generated by microwaves, are not subjected to any temperatures higher than that which is needed to release these products.

In one embodiment, the heating of the carbonaceous material 12 may be carried out by processes such as pyrolysis, partial oxidation, or a combination of these processes. In another embodiment, the heating of the carbonaceous material 12 may not involve a complete oxidation process. “Complete Oxidation” refers to the heating of the carbonaceous material 12 in the presence of stoichiometric or excess amounts of oxygen. The term “pyrolysis” refers to the heating of the carbonaceous material 12 in the absence of any oxygen, or in the presence of only minimal amounts of oxygen. “Partial oxidation” refers to the heating of the carbonaceous material 12 in the presence of sub-stoichiometric amounts of oxygen. Depending upon the configuration of the reactor 14, more than one of these reactions may occur. In one embodiment, the term “heating” used herein refers predominantly to oxygen-starved reactions such as pyrolysis and partial oxidation. In other embodiments, the pyrolysis may be carried out by employing a plasma mode of heating, or a non-plasma mode of heating. Configuring a plasma based mode of heating may extend the temperature range significantly, while maintaining significant energy efficiency. In one embodiment, the plasma may act as a catalyst, reducing the activation energy that is required to start the chemical dissociation of the carbonaceous material 12. In the pyrolysis mode of heating, oxygen may be removed entirely from the system to prevent oxidation of the carbonaceous material 12 during the heating process.

In one embodiment, a number of valves may be used at various locations in the system 10 to control the flow of carbonaceous material 12 and the mixture (which includes char, gas and oil) as well as to isolate various parts of the system. In another embodiment, one or more pumps may be employed to evacuate the system and the reactor, such that the treatment of the carbonaceous material 12 may be carried out in a low oxygen or an oxygen free environment. In another embodiment, a gas source may be included to provide a carrier gas, such as an inert gas like nitrogen or argon.

In some specific embodiments, at least a portion of the product mixture which results from treatment of the carbonaceous material (e.g., the pyrolysis oil products) is subjected to at least one upgrading step. A typical upgrading procedure is described in detail in Publication 2009/0259082 (Deluga et al; incorporated herein by reference), and involves a hydro-treating step. Hydro-treating can be followed by a hydro-isomerization step. The hydro-isomerization step can be followed by a separation step (e.g., using the techniques mentioned above), which separates various components of the isomerization products. The upgrading steps are designed to produce one or more deliverable fuel products.

### EXAMPLES

### Example 1

### Ex. 1

Treatment of carbonaceous material 12 containing sub-bituminous or powder river basin (PRB) coal was carried out according to an embodiment of the invention. About 30 grams of PRB coal obtained from Black Thunder Mine by Standard Laboratories, Inc was treated in a reactor with about 30 gram coal capacity, while nitrogen was purged into the system. The coal in the reactor was heated using microwave energy. The microwave energy was generated by a 6 kW magnetron, operated at a frequency of 2.45 GHZ. The microwave energy was transferred to the reactor using a wave guide. A volatiles cooling system was employed for the separation of light gases and the oil. The coal temperature was measured using a pyrometer. The yield of the oil obtained was calculated after the treatment was complete.

### Example 2

### Ex. 2

A similar procedure as described in Example 1 was employed for the treatment of the carbonaceous material containing 30 grams of bituminous coal (Pittsburgh 8 coal). The yield of the oil obtained on treatment of the bituminous coal using microwave energy was calculated.

### Comparative Example 1

### CEx. 1

Treatment of carbonaceous material containing sub-bituminous or powder river basin (PRB) coal was carried out using a conventional heating method. About 30 grams of PRB Coal obtained from Black Thunder Mine by Standard Laboratories, Inc was treated in a reactor with about 30 gram coal capacity, while nitrogen was purged into the system. The coal in the reactor was heated using an electric oven. A volatiles cooling system was employed for the separation of light gases and the oil. The coal temperature was measured using a thermocouple. The yield of the oil obtained was calculated.

### Comparative Example 2

### CEx. 2

A similar procedure as described in Comparative Example 1 was employed for the treatment of the carbonaceous material containing bituminous coal (Pittsburgh 8 coal). The yield of the oil obtained on treatment of the bituminous coal using microwave energy was calculated.

The comparative examples 1 and 2 (CEx. 1 and CEx. 2) were performed to establish a baseline for a conventional method of pyrolysis oils production from coal.

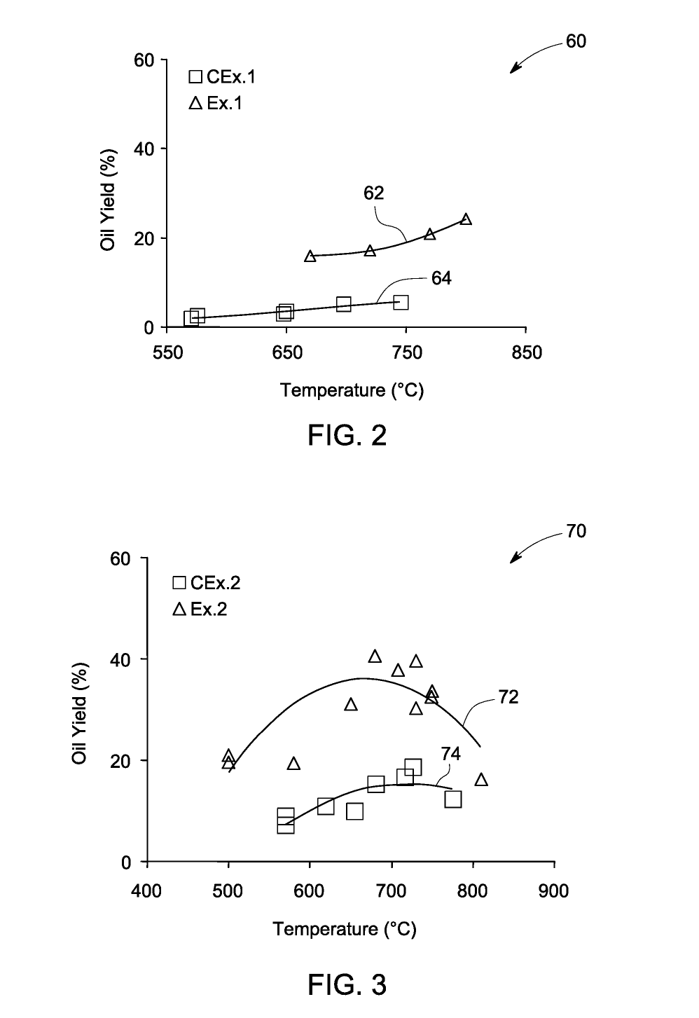

FIG. 2 illustrates a plot 60 of oil yield as a function of the temperature of the PRB coal subjected to treatment as described in Ex. 1(62) and CEx. 1 (64), according to another embodiment of the invention. As can be observed from the plot in FIG. 2, a high yield of oil (about 25%) was obtained for the PRB coal under microwave heating (curve 62). This yield was about 45% greater than that obtained by the convention heating method (curve 64).

FIG. 3 illustrates a plot 70 of oil yield as a function of the temperature of the bituminous coal subjected to treatment as described in Ex. 2 (72) and CEx. 2 (74), according to another embodiment of the invention. As can be observed from the plot in FIG. 3, a high yield of oil (about 40%) was obtained for the bituminous coal under microwave heating (curve 72). This yield was about 50% greater than that obtained by the convention heating method (curve 74). It should also be noted that an increase in oil yield, after microwave treatment, may not be attributable solely to faster heating rates, but can be attributed, in part, to the interaction of the microwave energy with the carbonaceous material.

This written description uses examples to disclose some embodiments of the invention, including the best mode, and also to enable any person skilled in the art to practice the invention, including making and using any devices or systems, and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A method of treating a carbonaceous material, comprising:
heating the carbonaceous material in a reactor with microwave energy at a pressure less than about 5 atmospheres, to generate a mixture comprising char, oil and gas.

2. The method according to claim 1, wherein the heating is carried out at a temperature in a range of about 400° C. to about 800° C.

3. The method according to claim 1, wherein the pressure is in a range from about 1 atmosphere to about 5 atmospheres.

4. The method according to claim 1, wherein the microwave energy is generated using a magnetron.

5. The method according to claim 1, wherein the microwave energy is transferred to the carbonaceous material, using a waveguide.

6. The method according to claim 1, further comprising separating the mixture of char, oil and gas.

7. The method according to claim 1, further comprising separating char from the mixture of char, oil and gas, in a cyclone disposed downstream of the reactor.

8. The method according to claim 7, wherein the char is recycled to the reactor.

9. The method according to claim 1, wherein the carbonaceous material comprises a mixtures of coal and biomass.

10. The method according to claim 1, wherein the carbonaceous material comprises a bituminous coal, a powder river basin coal, a lignite coal, or mixtures thereof.

11. The method according to claim 1, wherein the microwave energy is generated at a power in the range of about 100 kiloWatts per pound to about 1,000 kiloWatts per pound.

12. The method according to claim 1, wherein the heating is carried out in the absence of oxygen.

13. The method according to claim 1, wherein the heating step comprises pyrolysis.

14. The method according to claim 1, wherein the oil comprises pyro-oil.

15. The method according to claim 1, wherein the yield of the oil obtained is at least about 30 percent.

16. The method of claim 1, wherein at least a portion of the oil is subjected to at least one upgrading step.

17. The method of claim 16, wherein the upgrading step comprises hydro-treating.

18. The method of claim 17, wherein the hydro-treating step is followed by a hydro-isomerization step.

19. The method of claim 18, wherein the hydro-isomerization step is followed by at least one separation step, to separate at least some of the isomerization products.

20. A method of treating a carbonaceous material, comprising:
heating the carbonaceous material in a reactor with microwave energy at a pressure less than about 5 atmospheres, and a temperature in a range of about 400° C. to about 800° C., to generate a mixture comprising char, oil and gas.
